(19) United States
(12) Patent Application Publication
(10) Pub. No.: US 2017/0091713 A1
(43) Pub. Date: Mar. 30, 2017

(54) PRIVACY AWARE SHARING IMPLICIT AND EXPLICIT PERSONAL PREFERENCES FOR GROUP PLANNING

(71) Applicant: Yahoo! Inc., Sunnyvale, CA (US)

(72) Inventor: Jonathan Paris, Palo Alto, CA (US)

(21) Appl. No.: 14/866,505

(22) Filed: Sep. 25, 2015

(51) Int. Cl. G06Q 10/10; G06F 3/0482; G06F 3/0484

(52) U.S. Cl. CPC G06Q 10/1093; G06F 3/04847; G06F 3/0482

(57) ABSTRACT

Disclosed are methods and apparatus for facilitating group event planning are disclosed. Event planning preferences associated with two or more users are obtained, where the event planning preferences include a first set of event planning preferences of a first one of the users and a second set of event planning preferences of a second one of the users. The event planning preferences may include inferred user preferences and/or explicit user preferences. Event planning preferences may be inferred from data collected outside of the explicit event planning context. An event recommendation is determined based, at least in part, on the event planning preferences. Information pertaining to the event recommendation is provided to at least one of the users.

### BACKGROUND OF THE INVENTION

The present disclosure relates generally to computer implemented methods and apparatus for facilitating group planning.

Calendaring software offers users the ability to maintain an electronic calendar. An electronic calendar generally presents a view of dates and days of the week, as well as meetings or appointments that are scheduled within the calendar. Calendaring software generally provides a web-based interface that allows users to access their calendars from any computer or mobile device. Calendaring software is often a standard feature of many personal digital assistants (PDAs) and smartphones.

There are a number of ways that users may share their electronic calendars with others. For example, calendaring software typically enables users to export their calendar into a file that may be sent to specific individuals via electronic mail. As another example, users may grant other individuals permission to view their electronic calendar.

Prior to scheduling a meeting, an organizer may view the electronic calendars of other individuals to view their availability. Based upon the availability of the individuals, the organizer may select a date and time that the individuals can attend.

### SUMMARY OF THE INVENTION

In one embodiment, event planning preferences associated with two or more users are obtained, where the event planning preferences include a first set of event planning preferences of a first one of the users and a second set of event planning preferences of a second one of the users. An event recommendation is determined based, at least in part, on the event planning preferences. Information pertaining to the event recommendation is provided to at least one of the users.

In another embodiment, the invention pertains to a device comprising a processor, memory, and a display. The processor and memory are configured to perform one or more of the above described method operations. In another embodiment, the invention pertains to a computer readable storage medium having computer program instructions stored thereon that are arranged to perform one or more of the above described method operations.

These and other features and advantages of the present invention will be presented in more detail in the following specification of the invention and the accompanying figures which illustrate by way of example the principles of the invention.

### BRIEF DESCRIPTION OF THE DRAWINGS

FIG. 1 is a block diagram illustrating an example system in which various embodiments may be implemented.

FIG. 2 is a process flow diagram illustrating an example method of facilitating group event planning in accordance with various embodiments.

FIG. 3 is a diagram illustrating an example client device in which various embodiments may be implemented.

### DETAILED DESCRIPTION OF THE SPECIFIC EMBODIMENTS

Reference will now be made in detail to specific embodiments of the disclosure. Examples of these embodiments are illustrated in the accompanying drawings. While the disclosure will be described in conjunction with these specific embodiments, it will be understood that it is not intended to limit the disclosure to these embodiments. On the contrary, it is intended to cover alternatives, modifications, and equivalents as may be included within the spirit and scope of the disclosure as defined by the appended claims. In the following description, numerous specific details are set forth in order to provide a thorough understanding of the disclosure. The disclosed embodiments may be practiced without some or all of these specific details. In other instances, well known process operations have not been described in detail in order not to unnecessarily obscure the disclosure. The Detailed Description is not intended as an extensive or detailed discussion of known concepts, and as such, details that are known generally to those of ordinary skill in the relevant art may have been omitted or may be handled in summary fashion.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Currently, online movie rental systems enable multiple users to be identified in association with a single user account. In addition, these systems often provide movie recommendations to users of the user account. Since the users receiving the recommendations share the same user account, it is implicit that the users may wish to view movies together at a future time. However, these systems cannot provide recommendations for a group of individuals that do not share a user account.

The disclosed embodiments facilitate the planning of an event for a group of two or more individuals. Event recommendation(s) may be provided based, at least in part, on preferences of each of the individuals in the group. Event recommendations may include, but are not limited to, a date, a time, a venue (physical or virtual), a venue type (e.g., beach, park, coffee shop), a type of cuisine, specific content (e.g., a particular movie or play), a specific event (e.g., name of concert, fundraiser, or dance), a content type (e.g., comedy vs horror), and/or an entity (e.g., a singer or actor).

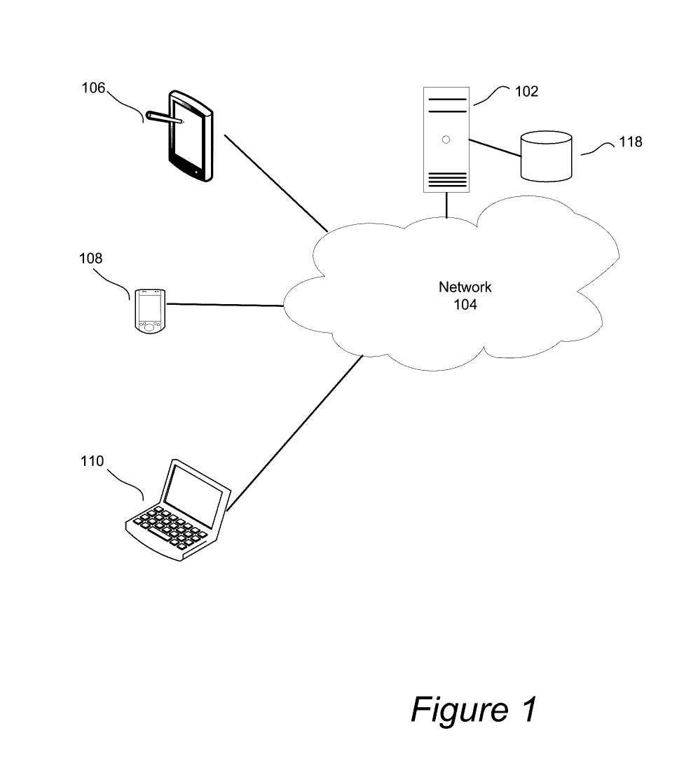

FIG. 1 is a diagram illustrating an example system in which various embodiments may be implemented. The disclosed embodiments may be implemented in some centralized manner. This is represented in FIG. 1 by server(s) 102, which may correspond to multiple distributed devices and data store(s). The server(s) 102 and/or corresponding data store(s) may store user account data, user information such as user profiles, query logs, search logs, user calendars, user preferences, event planning data, and/or content.

The server(s) 102 may be associated with a web site that provides a variety of services to its users. More particularly, the server(s) 102 may include a web server, electronic mail server, search server, and/or content server. As will be described in further detail below, the server(s) 102 may facilitate the planning of events for groups of individuals.

As shown, clients 106, 108, 110 may access an event planning application on the server(s) 102 via network 104. An event planning application may be implemented on any number of servers although only a single server 102 is illustrated for clarity. The client devices 106, 108, 110 may be implemented, for example, via any type of computer (e.g., desktop, laptop, tablet, etc.), media computing platforms (e.g., cable and satellite set top boxes), handheld computing devices (e.g., PDAs), cell phones, or any other type of computing or communication platform.

The network 104 may take any suitable form, such as a wide area network or Internet and/or one or more local area networks (LAN's). The network 104 may include any suitable number and type of devices, e.g., routers and switches, for forwarding search or web object requests from each client to the search or web application and search or web results back to the requesting clients.

The disclosed embodiments may be practiced in a wide variety of network environments (represented by network 104) including, for example, TCP/IP-based networks, telecommunications networks, wireless networks, etc. In addition, computer program instructions with which embodiments of the invention may be implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

Embodiments disclosed herein may be implemented via the server(s) 102 and/or the clients 106, 108, 110. For example, various features may be implemented via an event planning application installed on the clients 106, 108, 110, enabling group event planning to be facilitated via communications transmitted between the server(s) 102 and the clients 106, 108, 110 via the network 104. In addition, an event planning application may be in communication or integrated with a calendaring application installed on the server(s) 102 and/or the clients 106, 108, 110. The disclosed embodiments may be implemented via software and/or hardware.

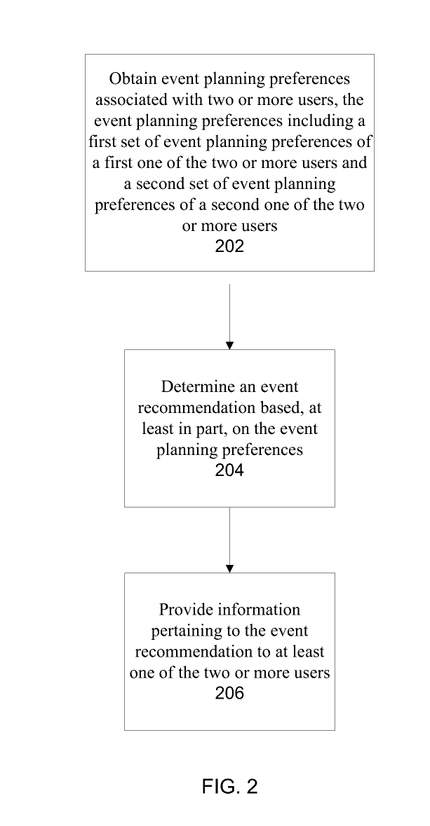

The server(s) 102 may facilitate event planning for a group of individuals based, at least in part, on preferences of each of the individuals. More particularly, the server(s) 102 may provide event recommendation(s) in response to event planning requests received from the clients 106, 108, 110 via the network 104. Various mechanisms for facilitating group event planning will be described in further detail below with reference to FIG. 2.

Individual preferences may include implicit preferences (e.g., inferred by the system) and/or explicit preferences provided by the corresponding individual. Implicit preferences may include those that are not specifically provided by the individual. More particularly, implicit preferences may include those that are inferred from prior behavior of the individual, either in the event planning context or outside the event planning context. The preferences of each individual may be retrieved from a user profile. An example user profile will be described in further detail below.

The server 102 (or servers) may have access to a plurality of user profiles of users. Each profile may be associated with a corresponding user represented by a user account, browser, and/or client device.

A variety of mechanisms may be implemented to support the generation or updating of user profiles including, but not limited to, collecting or mining navigation history, stored documents, tags, messages, or annotations, to provide a few examples. Profiles of users of a search engine, for example, may give a search engine provider a mechanism to retrieve annotations, tags, stored pages, navigation history, or the like, which may be useful for making relevance determinations of search results, such as with respect to a particular user.

In accordance with various embodiments, the server(s) 102 may have access to one or more user logs 118 (e.g., user databases) into which user information is retained for each of a plurality of users. This user information or a portion thereof may be referred to as a user profile. More particularly, the user profile may include public information that is available in a public profile and/or private information. The user logs 118 may be retained in one or more memories that are coupled to the server 102.

A user profile may be associated with one or more client devices. Conversely, each client device may be associated with a set of one or more users, enabling user profile(s) associated with the client device to be identified.

The user information retained in a user profile may indicate a plurality of features for a corresponding user. More particularly, the features may include personal information such as demographic information (e.g., age, marital status, and/or gender) and/or geographic information (e.g., residence address and/or work address). In addition, the features may indicate types of content consumed by the user, types of cuisine preferred by the user, specific restaurants that the user patronizes or other venues that the user prefers, interests of the user, and/or personality characteristics of the user.

In some embodiments, when the user submits a reservation for a restaurant via a reservation service such as OpenTable, the information pertaining to the restaurant is saved in the user profile. In other embodiments, the information pertaining to the restaurant may be saved after a threshold number of reservations for the restaurant have been submitted.

In some instances, the geographic information maintained in a user profile may indicate the current location of a user. The current location of a user may be identified based upon signals explicitly transmitted by the user or implicit signals. Examples of implicit signals include an Internet Protocol (IP) address or Global Positioning System (GPS) location of a client device, which may be used to infer a location of the user. As another example, the user's location may be implied through cell tower triangulation. In addition, a user may explicitly check in to a location via the use of a check in application, which may be accessed via a website and/or installed on a client device such as a mobile device.

In accordance with various embodiments, event planning preferences that have been explicitly supplied by the user may be maintained in the user profile. The event planning preferences may include preferences specific to a particular event planning request, preferences specific to particular individual(s) or groups, and/or preferences applicable to all event planning requests.

Event planning preferences may include a specific date, day of the week, time, time period, and/or time of day (e.g., morning, afternoon, evening, late night). In addition, the event planning preferences may include a user location from which the user intends to travel to the event, preferred maximum travel distance from their location(s) (e.g., work, home, current location, or specified user location), specific preferred venue(s) (e.g., specific movie theaters or restaurants), preferred types of events (e.g., concerts, movies, fundraising events), cuisine preferences (e.g., preferred type(s) of cuisine, gluten free, vegetarian), cost preferences, preferred content or entities (e.g., specific movie, band, comedian, etc.), and/or preferred types of content (e.g., movie or play).

A preference may be a positive preference or a negative preference. For example, a user's profile may indicate that the user likes movies (a positive preference) but does not like operas (a negative preference).

The event preferences may further indicate whether the user perceives a particular preference as mandatory (e.g., non-negotiable) or optional (e.g., preferable). A mandatory positive preference may be one that should always be satisfied. For example, where the user is a vegetarian, the user may indicate that a restaurant menu should always have vegetarian entrees. Similarly, a mandatory negative preference may indicate a circumstance that should never occur. For example, the user may indicate that they will not go to a prime rib restaurant or will not go to the opera.

In some embodiments, a level of importance may be associated with a particular preference. For example, where a user loves Chinese food, a level 10 may be associated with Chinese cuisine. As another example, where the user likes Italian cuisine but it isn't his favorite cuisine, a level 5 may be associated with Italian cuisine.

The event planning preferences may also include privacy settings that indicate which subset of the event planning preferences may be shared with other individuals. Moreover, the privacy settings may include multiple settings, where each different privacy setting indicates a subset of the event planning preferences that may be shared with a corresponding set of one or more individuals.

In addition, the privacy settings may indicate which portion of their calendar may be shared, as well as a corresponding set of individuals with which the portion of the calendar may be shared. For example, the user may wish to share a segment of their calendar showing the hours 9-5 Monday through Friday with their co-workers. As another example, the user may wish to share a segment of their calendar showing Saturday night, Sep. 5, 2015 with their friend Joe.

In some embodiments, a computer learning algorithm may be applied to learn a model that may be used to determine the preferences of the user. Thus, the user profile may include parameters of a computer-generated model associated with the user.

In addition, each time a user performs online activities such as clicking on a web page (or region thereof) or an advertisement, or purchasing goods or services, information regarding such activity or activities may be retained as user data in the user profile. For example, the user profile may indicate the identity of web sites visited, identity of ads that have been selected (e.g., clicked on), and/or a timestamp. In addition, the features may indicate a purchase history with respect to one or more products, one or more types of products, one or more services, and/or one or more types of services.

The user logs 118 may further include query logs into which search information is retained. Each time a user performs a search on one or more search terms, information regarding such search may be retained in the query logs. For instance, the user's search request may contain any number of parameters, such as user or browser identity and the search terms, which may be retained in the query logs. Additional information related to the search, such as a timestamp, may also be retained in the query logs along with the search request parameters. When results are presented to the user based on the entered search terms, parameters from such search results may also be retained in the query logs. For example, an identity of the specific search results (e.g., Uniform Resource Locators (URLs)), such as the web sites, the order in which the search results are presented, whether each search result is a sponsored or algorithmic search result, the owner (e.g., web site) of each search result, and/or whether each search result is selected (i.e., clicked on) by the user (if any), may be retained in the query logs.

Based upon a user's activities, the server(s) 102 may infer various preferences of the user. The server(s) 102 may update the user profile with these implicit event planning preferences. In addition, the server(s) 102 may assign probabilities to the implicit event planning preferences, where the probabilities indicate the likelihood that the corresponding implicit event planning preferences accurately reflect the desires of the user.

The system may recommend group events based upon the preferences of each of the individuals in the group. Example methods of providing event recommendations will be described in further detail below.

FIG. 2 is a process flow diagram illustrating an example method of facilitating group event planning in accordance with various embodiments. Group event planning services may be provided in response to receiving an event planning request pertaining to a group of two or more individuals. More particularly, a user may submit an event planning request by logging in to their user account. For example, a user may submit an event planning request via an event planning web page to receive an event recommendation for an event that may be attended by all of the individuals in the group. Alternatively, a user may submit an event planning request via an event planning application installed on a mobile device, by sending an electronic mail message, or a text message.

The user initiating the event planning request may be a member of the group, but need not be a member of the group. Thus, the request may identify two or more individuals or, alternatively, may identify the other individuals in the group. For example, each individual may be identified by an account identifier, user identifier, or electronic mail address. Alternatively, the request may identify a group identifier or electronic mail address, which may be mapped to specific individuals. Therefore, each of the individuals may have a separate user account that is maintained by the server(s) 102 or accessible by the server(s) 102.

In some instances, the user may have specific date(s), time(s), event(s), and/or event type(s) in mind. For example, the individuals in the group may have decided that they want to see a movie or a particular movie. As another example, the individuals in the group may have spoken about going out the following weekend for dinner and a movie.

In accordance with various embodiments, the request may include one or more parameters. Such parameters may indicate, for example, a number of events, particular event(s) (e.g., a specific movie), one or more event types (e.g., a movie, dinner, brunch, sporting event, theater production, wine tasting, etc.), specific date(s), specific time(s), specific day(s) of the week, specific time period(s), and/or time(s) of day. While an event may take place on a single day, an event may also include a vacation that takes place over multiple days. Where multiple sequential events (e.g., dinner and a movie) are requested, the user may indicate a preferred order of the sequential events.

In some embodiments, the system may not enable an event planning request to identify a specific event, a specific venue, or specific content. In other embodiments, the system may not support the provision of parameters for an event planning request. Therefore, the system may rely entirely on event planning preferences of each of the individuals in the group to provide an event recommendation.

Upon receiving the request, the server(s) 102 may obtain event planning preferences for the group, where the event planning preferences include a set of event planning preferences for each of the individuals in the group at 202. For example, each set of event planning preferences for a corresponding individual may indicate cuisine preferences, price preferences (e.g., price range or level), location/venue preferences, travel distance preferences, overall availability, available dates, available times, time of day availability, day of week availability, event type preferences, content preferences (e.g., content type), and/or entity preferences. A set of event planning preferences may further indicate more general preferences such as whether the corresponding individual enjoys trying new things or whether the individual likes to go to the same place every time they go out. In accordance with various embodiments, the event planning preferences for a given individual will not identify a particular event or specific content.

A set of event planning preferences may indicate a level of importance of a corresponding preference. For example, a level of importance to the user may be indicated by a numerical value within a range of 1-10. In addition, a set of event planning preferences may indicate whether a preference is optional or mandatory. For example, a preference may indicate that a particular circumstance should always be satisfied, never be satisfied, or may be optionally satisfied.

The set of event planning preferences for a given individual may include preferences that are implicit (e.g., inferred by the system) and/or preferences that are explicit (e.g., specified or otherwise indicated by the user via a graphical user interface). A set of event planning preferences may be retrieved, for example, from a database (e.g., user profile). For example, each set of event planning preferences may be represented by a corresponding vector of values.

In some embodiments, an individual may log in to their user account to establish, view, or modify their event planning preferences. More particularly, the server(s) may present a web page that enables an individual to submit their preferences for use in group event planning via at least one graphical user interface. For example, the web page may present, for a category (e.g., cuisine, content type) of user preferences, a set of selectable options from which one or more of the options may be selected. Event planning preferences may be stored in memory in association with the individual (e.g., in a user profile of the individual).

In addition, event planning preferences that are implicit may be inferred and stored in the user profile of the individual. More particularly, various event planning preferences may be inferred from behavior of the individual, as described herein. The implicit event planning preferences may be applied by the system, but may not be viewable by the individual via their user account.

The system may ascertain implicit event planning preferences of an individual based, at least in part, on information in the user profile of the individual and/or a calendar of the individual. More particularly, implicit location preference(s) of the user may be ascertained based, at least in part, on location(s) of the user. In addition, in some embodiments, the system may ascertain the preferred traveling distance from the individual's location (e.g., work or home) based, at least in part, on events previously attended by the individual (e.g., based upon previous events recommended by the system and accepted by the individual and/or the calendar of the user). For example, based upon the day of the week and the time of day, the system may determine whether the individual travelled from work or home to the particular event.

Event planning preferences may also be implied based, at least in part, on interests that have been explicitly specified by the individual in their user profile, as well as implied interests. Interests may include, but are not limited to, topics, products, businesses, celebrities, and/or upcoming events. Moreover, interests of the user may be inferred based upon interaction of the user with online documents and/or items that the user has “liked.” In addition, the system may identify events that an individual is interested in attending based, at least in part, on a calendar of the individual and/or whether the user has explicitly selected “I'm interested” for the event, search data obtained from the individual's search history, and/or the user's browsing history.

In some embodiments, an individual may establish a privacy setting. For example, the server(s) may present a web page that enables an individual to establish a privacy setting for group event planning More particularly, a first individual may log in to their user account and establish, via at least one graphical user interface, a privacy setting that may be applied in group event planning. As another example, an individual may establish a privacy setting via a text or voice command such as “share with Jon my weekend availability only.” The privacy setting may be stored in association with the first individual (e.g., the user profile of the first individual).

Privacy setting(s) of a user account may ensure that an individual has control of his or her information that is released during the group event planning process. More particularly, privacy settings may limit information that may be accessed by or provided to a particular individual or group of individuals. For example, privacy setting(s) may indicate a subset of the event planning preferences of a first individual that can be shared with (e.g., accessed by or provided to) other individual(s) in the group. As another example, privacy setting(s) may indicate a segment of a calendar of the first individual that can be shared with other individual(s) in the group. In addition, the privacy settings may indicate a segment of a calendar of an individual and/or subset of event planning preferences of the individual that may be accessed by the system in generating and providing an event recommendation. The subset of event planning preferences indicated by the individual may include preferences that are explicit (e.g., cuisine type) and/or those that are implicit (e.g., location). For example, an individual may select one or more of a plurality of event planning preference categories (e.g., location, cuisine type, event type, etc.) to indicate whether the selected categories of preferences are accessible or inaccessible by the system and/or other individuals. Privacy settings may be specific to a particular event planning request/session or may be applied in a global manner to all event planning processes/requests.

In some embodiments, an individual may opt in or opt out of group event planning services. More particularly, an individual may opt in for planning of a particular event. For example, where two different individuals that are members of a dating web site want to plan a date but do not wish to share their personal information with each other, they may submit a request or confirmation via the dating web site or event planning web site that they wish their information to be accessible for use by the event planning web site for the recommendation of event(s) for the date. As one example, an individual may confirm receipt of an event planning confirmation electronic mail message received from the event planning web site. As another example, the individual may log in to the event planning web site and confirm that they would like their information to be accessible for purposes of planning the date. In this manner, they may enable the event planning application to access their event planning preferences and calendar (or specific portion thereof) for use in planning the date without providing the other individual access to their event planning preferences or calendar.

At least one event recommendation may be determined at 204 based, at least in part, on the event planning preferences. For example, an event recommendation may include a date, a time, a venue (e.g., a particular movie theater or a particular restaurant), a specific event (e.g., fundraiser, concert, etc.), a type of event (e.g., dinner, a movie), a type of cuisine, specific content (e.g., a particular movie), a type of content (e.g., comedy vs horror), and/or a specific entity (e.g., Tom Cruise). As described above, the event planning preferences may include implicit preferences, as well as explicit preferences. Therefore, the event recommendation(s) may be determined based, at least in part, upon additional information in the user profile(s) of the individuals in the group.

At least one event recommendation may be ascertained based, at least in part, on the application of various heuristics to the event planning preferences and any event planning request parameters. These rules may be applied to a specific user, across a segment of users, or all users. In some embodiments, the event recommendation(s) may be ascertained via application of a machine learning algorithm. In this manner, the server(s) 102 may ascertain an optimum overlap of the vectors representing the individual preferences or a suitable compromise where an overlap of all of the vectors is not possible.

In some embodiments, the server(s) 102 may identify a plurality of candidate events based, at least in part, on any parameters of the event planning request and/or preferences (e.g., explicit and/or implicit) of each of the individuals in the group. The server(s) 102 may prioritize the candidate events based, at least in part, on the preferences (e.g., explicit and/or implicit preferences) of each of the individuals in the group. The server(s) 102 may then select at least one of the candidate events according to the priorities assigned to the candidate events. Each candidate event may include a date, a time, a venue, a specific event (e.g., fundraiser, concert, etc.), a type of event, a type of cuisine, specific content, a type of content, and/or a specific entity.

Candidate events may be identified by the server(s) 102 using information accessible in one or more event databases. In some embodiments, the databases may be maintained by the web site associated with the server(s) 102. In addition, candidate events may be identified via resources available on the Internet. For example, candidate events may be identified from web sites, which may include specific web sites that are accessed by the server(s) 102. The web sites may be accessed by the server(s) 102 in response to an event planning request. Alternatively, the web sites may be monitored by the server(s) 102 in real-time or on a periodic basis to update the event databases. Events may be extracted from various web sites using pattern recognition, entity recognition, natural language processing, or other suitable methods.

To determine an event recommendation, the server(s) 102 may attempt to satisfy the event planning preferences of each of the individuals in the group. More particularly, the server(s) may attempt to the satisfy event planning preferences of the individuals based, at least in part, on corresponding levels of importance and/or indicators of whether the event planning preferences are mandatory (e.g., as indicated by the individual). For example, where one of the individuals is a vegetarian, the preference that a restaurant be a vegetarian restaurant may be optional, while the preference that a restaurant offer vegetarian options on the menu may be mandatory.

The server(s) 102 may prioritize and/or select event(s) to balance the preferences of the various individuals in the group. For example, the prioritization of events and/or selection of event(s) may be performed to maximize the total number of preferences that are satisfied, maximize the total number of explicit preferences that are satisfied, maximize the number of preferences that are satisfied per individual, maximize the number of explicit preferences that are satisfied per individual, maximize the average number of preferences that are satisfied per individual, and/or maximize the average number of explicit preferences that are satisfied per individual.

Satisfaction of some preference types may be prioritized over other preference types. For example, date or time availability may be prioritized over content preferences. As yet another example, explicit preference types (e.g., cuisine or cost) indicating preferences explicitly specified or indicated by an individual may be prioritized over implicit preference types (e.g., content) indicating preferences that have merely been inferred by the system (e.g., based upon browsing or searching history). Where an explicit preference of an individual directly conflicts with an implicit preference of the individual, the system may prioritize between the explicit and implicit preferences based, at least in part, on confidence of the implicit preference, recency of indicators of the implicit preference and the explicit preference, and/or impact of the preference (e.g. allergies). For example, where the impact of the preference can be significant, the system may prioritize the explicit preference over the implicit preference.

In some embodiments, weights or priorities may be assigned to the preferences of the different individuals in the group. For example, weights or priorities may be assigned based, at least in part, on the type or strength of the relationship an individual in the group has with the user. The type of relationship may be ascertained, at least in part, from a user's contacts or a user's web page in a social network. Similarly, the strength of the relationship of an individual in the group with the user may be ascertained, at least in part, on frequency of communications between the user and the individual (e.g., via a social network, mobile phone calls, and/or short message service (SMS) messages). As another example, the satisfaction of a particular preference type (e.g., date/time availability) may be weighted more heavily than another preference type (e.g., content preference). As yet another example, the preferences of the user that submitted the event planning request or individuals that frequently submit event planning requests may be weighted more significantly than the other individuals in the group.

In some embodiments, the server(s) 102 may attempt to identify an event that is centrally located or conveniently located to all of the individuals. More particularly, the system may determine the likely location of each individual in the group on the day(s) of the week or date(s) being considered by the system. For example, if the event is on Saturday night, the system may assume that the individuals may be travelling from home. As another example, if the event is on Monday at 5:00 PM, the system may assume that the individuals may be travelling from work. From the likely location of each individual, the system may determine the distance that each individual would travel from that location to a candidate event. Candidate events may be prioritized based, at least in part, on the travel distances of the individuals in the group. For example, candidate events may be prioritized based, at least in part, on the average travel distance for each individual in the group to the candidate event and/or the maximum travel distance of individuals in the group to the candidate event.

The user may have requested that multiple sequential events be recommended. For example, the user may have submitted an event planning request for dinner and a movie. In these instances, the server(s) 102 may attempt to minimize the travel distance between the sequential events. For example, the server(s) 102 may attempt to select a restaurant that is in close proximity to the movie theater.

Similarly, the server(s) 102 may attempt to satisfy all of the individuals with respect to cost preferences. Where cost preferences of the individuals substantially differ, the server(s) 102 may attempt to identify an event that satisfies the individual willing to spend the least.

In some embodiments, the system may avoid recommending an event that one of the individuals in the group has already attended or is planning on attending. More particularly, where an event is a theater production or movie, the system may assume that individual will not wish to attend the event more than once. However, where an event is a dinner or brunch and an individual has already gone to a restaurant multiple times, the system may assume that the individual liked the restaurant and may recommend going to the restaurant again.

The system may ascertain that an individual has already attended an event or already has plans to attend the event from a variety of sources. For example, the system may ascertain from a calendar of the user that the user has already seen a particular movie or already has tickets to a particular theater production. As another example, the system may ascertain that the individual has clicked “Buy Ticket(s)” for an event, booked a flight, hotel reservations, and/or car reservations.

Information pertaining to the event recommendation(s) may be provided to at least one of individuals in the group at 206. An event recommendation may include a date, a time, a venue (e.g., name and/or location), a specific event (e.g., event name), a type of event, a type of cuisine, specific content, a type of content, and/or a specific entity. For example, an event recommendation may identify the movie “When Harry Met Sally,” the date Sep. 25, 2015, and the times 7:55 and 8:15 along with the names and/or locations of corresponding movie theaters. The information may be provided to the user in response to an event planning request submitted by the user. In some embodiments, information may be provided to all of the individuals in the group. For example, an electronic mail message may be transmitted to each of the individuals in the group.

In some embodiments, the information may include an explanation or background for a particular recommendation. For example, the information may identify a particular Italian restaurant, and may further indicate that the Italian restaurant serves vegetarian entrees and is centrally located to all of the individuals in the group. As another example, the information may identify a particular theater and a particular restaurant, and indicate that the theater is 1 block from the recommended restaurant.

Where the event planning preferences of all of the individuals could not be satisfied, the information may indicate which preferences could not be satisfied. Alternatively, where the event planning preferences of all of the individuals could not be satisfied, the information may indicate a compromise that was made in providing the event recommendation. If the individuals are not happy with the event recommendation, a new event planning request may be submitted indicating the parameter(s) that are to be satisfied in the next event recommendation that is provided to the group. The server(s) 102 may record information that indicates that the recommendation for the previous event planning request was not accepted and any new event planning parameters.

In some embodiments, the information and/or amount of information that is provided to various individuals in the group may differ. More particularly, information pertaining to the event recommendation may be provided based, at least in part, on the privacy setting (e.g., sharing preferences) of the various individuals in the group. Where an individual has enabled access to specific preferences (e.g., cuisine preferences, distance preferences, or location preferences), information pertaining to these preferences may be provided in conjunction with the event recommendation or in response to a request for access to this information from another individual. Similarly, where an individual has enabled access to a specific portion of their calendar, information pertaining to the specific portion of the calendar may be provided in conjunction with the event recommendation or in response to a request for access to the calendar from another individual.

While the privacy setting(s) of an individual may prevent access to his or her preferences, calendar, or portion thereof by other individual(s) in the group, the server(s) 102 may still access the preferences and calendar to provide event recommendations. Therefore, event recommendations for groups of individuals that best satisfy the preferences of the individuals may be provided while maintaining the privacy of each of the individuals.

In some embodiments, the information that is provided may further include a hypertext link or Uniform Resource Locator (URL). In some embodiments, the hypertext link or URL may provide access to a web site that facilitates making reservations or purchasing tickets for the recommended event. For example, the information may provide a hypertext link or URL for OpenTable. In other embodiments, confirmation that the individual(s) will attend the recommended group event may be submitted via the hypertext link or URL. Upon receiving confirmation that each of the individuals in the group will attend the recommended group event, the system may record the event in the calendar of each of the individuals or book a reservation online for the recommended event for the number of individuals in the group. The reservation may be booked under the name of the user who submitted the event planning request.

In accordance with various embodiments, advertisements or offers may be provided to the individuals in the group or the specific user that submitted the event planning request. More particularly, the information that is provided may include an advertisement or offer that provides an incentive for the group to proceed with or confirm the recommended event. For example, the restaurant Chevy's may provide an offer that gives each individual a free drink.

The system may collect and maintain event information pertaining to event recommendations (e.g., type of event, day of the week, time of day, etc.), the size of the groups, whether the corresponding event recommendations are accepted, and/or correlations between advertisements/offers and acceptance of event recommendations. From this event information, the system may generate statistical data, which may be provided to advertisers. The statistical data may indicate the number of groups planning various types of events and the size of those groups. For example, the statistical data may indicate that there are approximately 300 groups that are planning dinners per week, approximately 30 percent of those groups include 2 people and approximately 50 percent of those groups include 4 or more people. Presentation of advertisements or offers to groups of individuals in conjunction with event recommendations may be priced based, at least in part, on the statistical data.

The system may monitor responses of individuals that are received in response to event recommendations provided by the system. In some embodiments, individual(s) in the group that receive information pertaining to the event recommendation may accept the event recommendation or reject the event recommendation. Based on such responses, the system may update its rules or a machine generated model. In some embodiments, a machine learning algorithm may learn to provide better event recommendations based, at least in part, on the responses to the event recommendations. Thus, the system may provide event recommendations for a group of individuals based, at least in part, on an interaction history of the individuals with event recommendations previously provided by the system.

The above-described embodiments disclose various example implementations for facilitating group event planning in response to a user request. However, in other embodiments, group event planning recommendations may also be provided for a group of individuals automatically without initiation by a user.

Network Environment

Event planning requests and recommendations may be transmitted in any of a wide variety of computing contexts. For example, implementations are contemplated in which users interact with a diverse network environment via any type of computer (e.g., desktop, laptop, tablet, etc.), media computing platforms (e.g., cable and satellite set top boxes and digital video recorders), handheld computing devices (e.g., PDAs), cell phones, or any other type of computing or communication platform.

Implementations are contemplated in which users interact with a diverse network environment. For example, the network environment may include a variety of networks.

A network may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, or any combination thereof. Likewise, sub-networks, such as may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

Event planning recommendations may be identified and retrieved via a content distribution network. A distributed system may include a content distribution network. A “content delivery network” or “content distribution network” (CDN) generally refers to a distributed content delivery system that comprises a collection of computers or computing devices linked by a network or networks. A CDN may employ software, systems, protocols or techniques to facilitate various services, such as storage, caching, communication of content, or streaming media or applications. Services may also make use of ancillary technologies including, but not limited to, “cloud computing,” distributed storage, DNS request handling, provisioning, signal monitoring and reporting, content targeting, personalization, or business intelligence. A CDN may also enable an entity to operate or manage another's site infrastructure, in whole or in part.

Event recommendations may also be identified and presented in a peer-to-peer network. A peer-to-peer (or P2P) network may employ computing power or bandwidth of network participants in contrast with a network that may employ dedicated devices, such as dedicated servers, for example; however, some networks may employ both as well as other approaches. A P2P network may typically be used for coupling devices via an ad hoc arrangement or configuration. A peer-to-peer network may employ some devices capable of operating as both a “client” and a “server.”

In some embodiments, the network environment may include a wireless network that couples client devices with a network. A wireless network may employ stand-alone ad-hoc networks, mesh networks, Wireless LAN (WLAN) networks, cellular networks, or the like.

A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

Communications transmitted via a network typically include signal packets. Signal packets communicated via a network, such as a network of participating digital communication networks, may be compatible with or compliant with one or more protocols. Signaling formats or protocols employed may include, for example, TCP/IP, UDP, DECnet, NetBEUI, IPX, Appletalk, or the like. Versions of the Internet Protocol (IP) may include IPv4 or IPv6.

Signal packets may be communicated between devices of a network, such as, for example, to one or more sites employing a local network address. A signal packet may, for example, be communicated over the Internet from a user site via an access device coupled to the Internet. Likewise, a signal packet may be forwarded via network devices to a target site coupled to the network via a network access device, for example. A signal packet communicated via the Internet may, for example, be routed via a path of gateways, servers, etc. that may route the signal packet in accordance with a target address and availability of a network path to the target address.

Various embodiments may be employed via one or more servers. A computing device that is capable of sending or receiving signals, such as via a wired or wireless network, or capable of processing or storing signals, such as in memory as physical memory states, may operate as a server. Devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

Event recommendations may be identified or provided via a content server. A content server may comprise a device that includes a configuration to provide content via a network to another device. A content server may, for example, host a site, such as a social networking site, examples of which may include, without limitation, Flicker, Twitter, Facebook, LinkedIn, or a personal user site (such as a blog, vlog, online dating site, etc.). A content server may also host a variety of other sites, including, but not limited to business sites, educational sites, dictionary sites, encyclopedia sites, wikis, financial sites, government sites, etc.

A content server may further provide a variety of services that include, but are not limited to, web services, third-party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example.

Examples of devices that may operate as a content server include desktop computers, multiprocessor systems, microprocessor-type or programmable consumer electronics, etc.

Input that is processed in accordance with the disclosed embodiments may be obtained using a wide variety of techniques. More particularly an event planning request, event planning preferences, or privacy settings may be submitted via a user's interaction with a local application, web site or web-based application or service and may be accomplished using any of a variety of well-known mechanisms for obtaining information from a user. Example mechanisms for obtaining user input include, but are not limited to, obtaining input via a graphical user interface, voice-based interface, or text-based interface. However, it should be understood that such methods of obtaining input from a user are merely examples and that user input may be obtained in many other ways.

Client Device

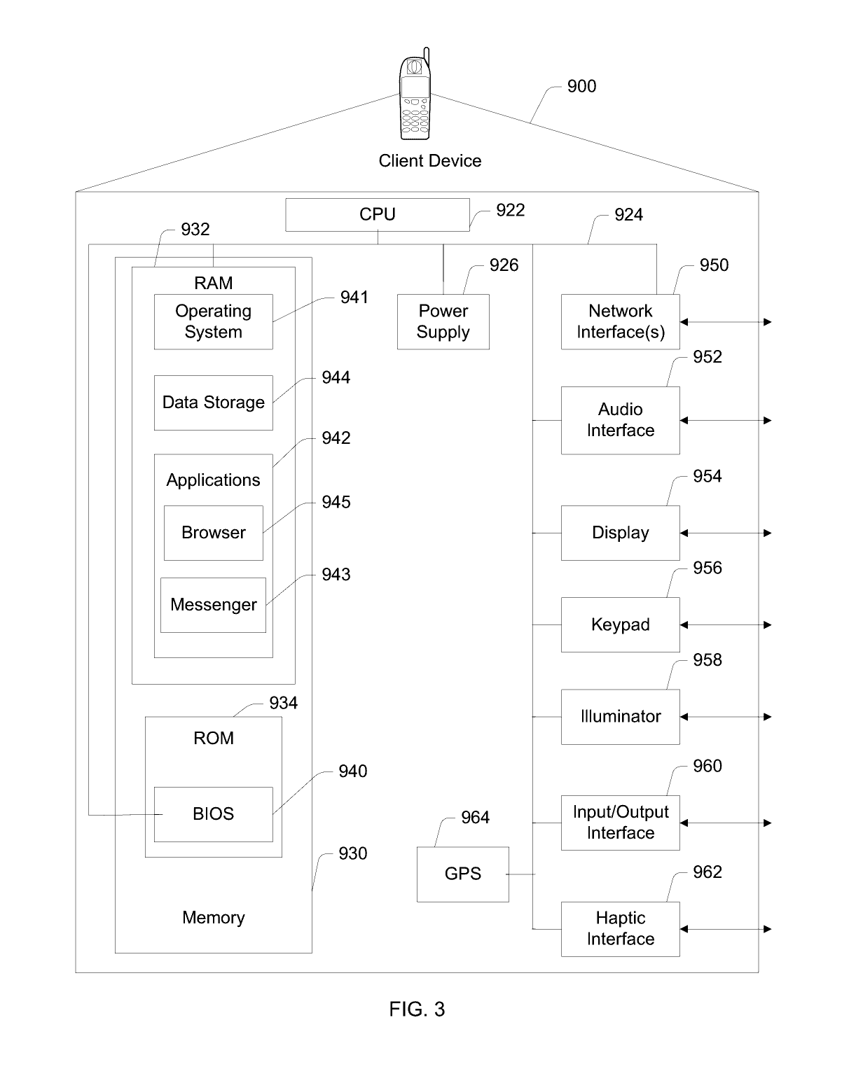

FIG. 3 is a schematic diagram illustrating an example embodiment of a client device in which various embodiments may be implemented. A client device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like. A portable device may also be referred to as a mobile device or handheld device.

As shown in this example, a client device 900 may include one or more central processing units (CPUs) 922, which may be coupled via connection 924 to a power supply 926 and a memory 930. The memory 930 may include random access memory (RAM) 932 and read only memory (ROM) 934. The ROM 934 may include a basic input/output system (BIOS) 940.

The RAM 932 may include an operating system 941. More particularly, a client device may include or may execute a variety of operating systems, including a personal computer operating system, such as a Windows, iOS or Linux, or a mobile operating system, such as iOS, Android, or Windows Mobile, or the like. The client device 900 may also include or may execute a variety of possible applications 942 (shown in RAM 932), such as a client software application such as messenger 943, enabling communication with other devices, such as communicating one or more messages, such as via email, short message service (SMS), or multimedia message service (MMS), including via a network, such as a social network, including, for example, Facebook, LinkedIn, Twitter, Flickr, or Google, to provide only a few possible examples. The client device 800 may also include or execute an application to communicate content, such as, for example, textual content, multimedia content, or the like, which may be stored in data storage 944. A client device may also include or execute an application such as a browser 945 to perform a variety of possible tasks, such as browsing, searching, playing various forms of content, including locally stored or streamed video, or games (such as fantasy sports leagues).

The client device 900 may send or receive signals via one or more interface(s). As shown in this example, the client device 900 may include one or more network interfaces 950. The client device 900 may include an audio interface 952. In addition, the client device 900 may include a display 954 and an illuminator 958. The client device 900 may further include an Input/Output interface 960, as well as a Haptic Interface 962 supporting tactile feedback technology.

The client device 900 may vary in terms of capabilities or features. Claimed subject matter is intended to cover a wide range of potential variations. For example, a cell phone may include a keypad such 956 such as a numeric keypad or a display of limited functionality, such as a monochrome liquid crystal display (LCD) for displaying text. In contrast, however, as another example, a web-enabled client device may include one or more physical or virtual keyboards, mass storage, one or more accelerometers, one or more gyroscopes, global positioning system (GPS) 964 or other location identifying type capability, or a display with a high degree of functionality, such as a touch-sensitive color 2D or 3D display, for example. The foregoing is provided to illustrate that claimed subject matter is intended to include a wide range of possible features or capabilities.

In some embodiments, an identity of the user (e.g., owner) of the client device may be statically configured. Thus, the device may be keyed to an owner or multiple owners. In other embodiments, the device may automatically determine the identity of the user of the device. For instance, a user of the device may be identified by deoxyribonucleic acid (DNA), retina scan, and/or finger print. From the identity of the user, a user profile and/or client profile may be identified or obtained.

Regardless of the system's configuration, it may employ one or more memories or memory modules configured to store data, program instructions for the general-purpose processing operations and/or the inventive techniques described herein. For example, the program instructions may control the operation of one or more applications. The memory or memories may also be configured to store instructions for performing the disclosed methods, graphical user interfaces to be displayed in association with the disclosed methods, etc.

Because such information and program instructions may be employed to implement the systems/methods described herein, the disclosed embodiments relate to machine readable media that include program instructions, state information, etc. for performing various operations described herein. Examples of machine-readable media include, but are not limited to, magnetic media such as hard disks and magnetic tape; optical media such as CD-ROM disks; magneto-optical media such as optical disks; and hardware devices that are specially configured to store and perform program instructions, such as ROM and RAM. Examples of program instructions include both machine code, such as produced by a compiler, and files containing higher level code that may be executed by the computer using an interpreter.

Computer program instructions with which various embodiments are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

The disclosed techniques may be implemented in any suitable combination of software and/or hardware system, such as a web-based server or desktop computer system. An apparatus and/or web browser may be specially constructed for the required purposes, or it may be a general-purpose computer selectively activated or reconfigured by a computer program and/or data structure stored in the computer. The processes presented herein are not inherently related to any particular computer or other apparatus. In particular, various general-purpose machines may be used with programs written in accordance with the teachings herein, or it may be more convenient to construct a more specialized apparatus to perform the disclosed method steps.

Although the foregoing embodiments have been described in some detail for purposes of clarity of understanding, it will be apparent that certain changes and modifications may be practiced within the scope of the appended claims. Therefore, the present embodiments are to be considered as illustrative and not restrictive and the invention is not to be limited to the details given herein, but may be modified within the scope and equivalents of the appended claims.

What is claimed is:

1. A method, comprising:
obtaining event planning preferences associated with two or more users, the event planning preferences including a first set of event planning preferences of a first one of the two or more users and a second set of event planning preferences of a second one of the two or more users;
determining, by a processor, an event recommendation based, at least in part, on the event planning preferences; and
providing information pertaining to the event recommendation to at least one of the two or more users.

2. The method as recited in claim 1, further comprising:
receiving, via a graphical user interface, at least a portion of the first set of event planning preferences; and
storing the at least a portion of the first set of event planning preferences in association with the first one of the two or more users.

3. The method as recited in claim 1, further comprising:
inferring at least a portion of the first set of event planning preferences based, at least in part, on at least one of a location of the first one of the two or more users, a browsing history of the first one of the two or more users, or a search history of the first one of the two or more users; and
storing the at least a portion of the first set of event planning preferences in association with the first one of the two or more users.

4. The method as recited in claim 1, further comprising:
obtaining a privacy setting associated with the first one of the two or more users, wherein the privacy setting indicates at least one of a subset of the first set of event planning preferences that can be shared with the second one of the two or more users or a segment of a calendar of the first one of the two or more users that can be shared with the second one of the two or more users; and
storing the privacy setting in association with the first one of the two or more users.

5. The method as recited in claim 1, further comprising:
providing information pertaining to at least a portion of the subset of the first set of event planning preferences or a segment of a calendar of the first one of the two or more users according to a privacy setting associated with the first one of the two or more users.

6. The method as recited in claim 1, wherein each set of event planning preferences indicates one or more of cuisine preferences, price preferences, location preferences, travel distance preferences, overall availability, available dates, available times, time of day availability, day of week availability, content preferences, content type preferences, entity preferences, or event type preferences.

7. The method as recited in claim 1, wherein the event recommendation comprises one or more of a venue, a specific event, a type of event, a type of cuisine, specific content, a type of content, or a specific entity.

8. The method as recited in claim 1, further comprising:
receiving an event planning request, wherein the event planning request does not identify a specific event, a specific venue, or specific content;
wherein the information pertaining to the event recommendation is provided in response to the event planning request.

9. A non-transitory computer-readable storage medium storing thereon computer-readable instructions, comprising:
instructions for obtaining event planning preferences associated with two or more users, the event planning preferences including a first set of event planning preferences of a first one of the two or more users and a second set of event planning preferences of a second one of the two or more users;
instructions for determining an event recommendation based, at least in part, on the event planning preferences; and
instructions for providing information pertaining to the event recommendation to at least one of the two or more users.

10. The non-transitory computer-readable storage medium as recited in claim 9, further comprising:
instructions for obtaining, via a graphical user interface, at least a portion of the first set of event planning preferences; and
instructions for storing the at least a portion of the first set of event planning preferences in association with the first one of the two or more users.

11. The non-transitory computer-readable storage medium as recited in claim 9, further comprising:
instructions for obtaining a privacy setting associated with the first one of the two or more users, wherein the privacy setting indicates at least one of a subset of the first set of event planning preferences or a segment of a calendar of the first one of the two or more users that can be used to determine the event recommendation; and
instructions for storing the privacy setting in association with the first one of the two or more users;
wherein the event recommendation is determined according to the privacy setting.

12. The non-transitory computer-readable storage medium as recited in claim 9, further comprising:
instructions for providing information pertaining to at least a portion of the subset of the first set of event planning preferences or a segment of a calendar of the first one of the two or more users according to a privacy setting associated with the first one of the two or more users.

13. The non-transitory computer-readable storage medium as recited in claim 9, wherein each set of event planning preferences indicates one or more of cuisine preferences, price preferences, location preferences, travel distance preferences, overall availability, available dates, available times, time of day availability, day of week availability, content type preferences, entity preferences, or event type preferences.

14. The non-transitory computer-readable storage medium as recited in claim 9, wherein the event recommendation comprises one or more of a date, a time, a venue, a specific event, a type of event, a type of cuisine, specific content, a type of content, or a specific entity.

15. The non-transitory computer-readable storage medium as recited in claim 9, further comprising:
instructions for obtaining an event planning request.
wherein the information pertaining to the event recommendation is provided in response to the event planning request.

16. An apparatus, comprising:
a processor; and
a memory storing thereon instructions configured to:
obtain event planning preferences associated with two or more users, the event planning preferences including a first set of event planning preferences of a first one of the two or more users and a second set of event planning preferences of a second one of the two or more users;
determine an event recommendation based, at least in part, on the event planning preferences; and
provide information pertaining to the event recommendation to at least one of the two or more users.

17. The apparatus as recited in claim 16, wherein the instructions are further configured to:
obtain, via a graphical user interface, at least a portion of the first set of event planning preferences; and
store the at least a portion of the first set of event planning preferences in association with the first one of the two or more users.

18. The apparatus as recited in claim 16, wherein the instructions are further configured to:
obtain a privacy setting associated with the first one of the two or more users, wherein the privacy setting indicates at least one of a subset of the first set of event planning preferences that can be shared with the second one of the two or more users or a segment of a calendar of the first one of the two or more users that can be shared with the second one of the two or more users; and
store the privacy setting in association with the first one of the two or more users.

19. The apparatus as recited in claim 16, wherein the instructions are further configured to:
provide information pertaining to at least a portion of the subset of the first set of event planning preferences or a segment of a calendar of the first one of the two or more users according to a privacy setting associated with the first one of the two or more users.

20. The apparatus as recited in claim 16, wherein each set of event planning preferences indicates one or more of cuisine preferences, price preferences, location preferences, travel distance preferences, overall availability, available dates, available times, time of day availability, day of week availability, content type preferences, entity preferences, or event type preferences; and
wherein the event recommendation comprises one or more of a date, a time, a venue, a specific event, a type of event, a type of cuisine, specific content, a type of content, or a specific entity.
